(19) United States
(12) Patent Application Publication
(10) Pub. No.: US 2023/0401460 A1
(43) Pub. Date: Dec. 14, 2023

(54) METHOD AND ELECTRONIC DEVICE FOR ON-DEVICE LIFESTYLE RECOMMENDATIONS

(71) Applicant: SAMSUNG ELECTRONICS CO., LTD., Suwon-si (KR)

(72) Inventors: Mahesh Badari Narayana Gupta, Bengaluru (IN); Sreenath DINDUKURTHI, Bengaluru (IN); Amit Arvind MANNIKAR, Bengaluru (IN); Mayank SINGH, Bengaluru (IN)

(73) Assignee: SAMSUNG ELECTRONICS CO., LTD., Suwon-si (KR)

(21) Appl. No.: 18/080,447

(22) Filed: Dec. 13, 2022

(30) Foreign Application Priority Data
Dec. 13, 2021 (IN) 202141057905

(51) Int. Cl. G06N 5/022; G06N 3/0464

(52) U.S. Cl. CPC G06N 5/022; G06N 3/0464

(57) ABSTRACT

A method of an electronic device for on-device lifestyle recommendations, includes: receiving a user input; determining a fashion context based on the user input; dynamically clustering fashion objects in at least one image stored in the electronic device based on the fashion context; and displaying a lifestyle recommendation including the clustered fashion objects.

### CROSS-REFERENCE TO RELATED APPLICATION(S)

This application is based on and claims priority under 35 U.S.C. § 119 to Indian Provisional Application No. 202141057905, filed on Dec. 13, 2021, and Indian Complete Application No. 202141057905, filed on Nov. 10, 2022, the disclosures of which are incorporated by reference herein in their entireties.

### BACKGROUND

### 1. Field

The present disclosure relates to an electronic device, and more specifically, to a method and the electronic device for on-device lifestyle recommendations.

### 2. Description of Related Art

Fashion is an integral part of human life. Access to fashion trends in the real world is available. But, channelizing and analyzing user's fashion and bringing the right content in the right context with respect to fashion trends are not available. A user can connect to current trends of fashion easily only upon knowing his/her own style appropriately. A bridge between one's fashion and fashion trends outside is a missing connection. Thus, it is desired to provide a useful method and/or system for bridging the user's fashion and the fashion trends in the real world.

Segmenting the identified fashion objects from the image includes determining a feature vector of the image using a Convolution Neural Network (CNN) model; determining Region of Interests (ROIs) of the image by providing the feature vector to a Region Proposal Network (RPN); optimizing scales of the ROIs by providing the feature vector and the predicted ROIs to a Feature Pyramid Network (FPN); refining an alignment of the ROIs; and determining the segmented fashion objects including output masks, labels, and coordinates of the identified fashion objects in the ROIs using a plurality of neural network models.

### SUMMARY

Provided is a method for on-device lifestyle recommendations.

According to an aspect of the disclosure, a method of an electronic device for on-device lifestyle recommendations, includes: receiving a user input; determining a fashion context based on the user input; dynamically clustering fashion objects in at least one image stored in the electronic device based on the fashion context; and displaying a lifestyle recommendation including the clustered fashion objects.

The dynamically clustering the fashion objects in the at least one image may include: identifying the fashion objects in the at least one image by analyzing the at least one image stored using an artificial intelligence (AI) model; generating a fashion knowledge graph including different classes of the identified fashion objects; traversing the fashion context through the fashion knowledge graph; and dynamically clustering the fashion objects in the different classes obtained based on the traversal.

The method may further include updating the fashion knowledge graph based on a user action on the recommendation.

The method may further include updating the fashion knowledge graph based on receiving and analyzing a new image.

The generating the fashion knowledge graph may include: segmenting the identified fashion objects from the image; classifying the segmented fashion objects to different classes; determining personal and social attributes of the segmented fashion objects in the different classes; and generating the fashion knowledge graph including the different classes of the segmented fashion objects, wherein each segmented fashion object in each class is assigned with either a personal tag or a social tag based on the personal and social attributes.

The dynamically clustering the fashion objects in the different classes may include: determining a weightage of a match between the at least one class of segmented fashion objects and the fashion context; and dynamically clustering the segmented fashion objects with the assigned tag in the at least one class based on the weightage.

The segmenting the identified fashion objects from the image may include: determining a feature vector of the image using a Convolution Neural Network (CNN) model; determining Region of Interests (ROIs) of the image by providing the feature vector to a Region Proposal Network; optimizing scales of the ROIs by providing the feature vector and the predicted ROIs to a Feature Pyramid Network (FPN); refining an alignment of the ROIs; and determining the segmented fashion objects including output masks, labels, and coordinates of the identified fashion objects in the ROIs using a plurality of neural network models.

The classifying the segmented fashion objects to the different classes may include: obtaining labels of the segmented fashion objects; and performing one of: based on the labels of the segmented fashion objects being clothes, classifying the segmented fashion objects into a pattern class, a fabric class, and an attire class, and based on the labels of the segmented fashion objects being fashion accessories, classifying the segmented fashion objects into a fashion accessory class.

The determining the personal and social attributes of the segmented fashion objects in the different classes may include: identifying each person in the image by detecting faces of people in the image; determining a relationship of each person with a user of the electronic device; segregating the segmented fashion objects of each person; and determining the personal and social attributes of the segregated fashion objects based on the relationship of each person with the user.

According to an aspect of the disclosure, an electronic device for on-device lifestyle recommendations, includes: a display; a memory storing instructions; a processor configured to execute the instructions to: detect a user input on the electronic device; determine a fashion context based on the user input; dynamically cluster fashion objects in at least one image stored in the electronic device based on the fashion context; and control the display to display a lifestyle recommendation including the clustered fashion objects.

The processor may be further configured to execute the instructions to: identify the fashion objects in the at least one image by analyzing the at least one image stored using an artificial intelligence (AI) model; generate a fashion knowledge graph including different classes of the identified fashion objects; traverse the fashion context through the fashion knowledge graph; and dynamically cluster the fashion objects in the different classes obtained based on the traversal.

The processor may be further configured to execute the instructions to update the fashion knowledge graph based on a user action on the recommendation.

The processor may be further configured to execute the instructions to update the fashion knowledge graph based on receiving and analyzing a new image.

The processor may be further configured to execute the instructions to: segment the identified fashion objects from the image; classify the segmented fashion objects to different classes; determine personal and social attributes of the segmented fashion objects in the different classes; and generate the fashion knowledge graph including the different classes of the segmented fashion objects, wherein each segmented fashion object in each class is assigned with either a personal tag or a social tag based on the personal and social attributes.

The processor may be further configured to execute the instructions to: determine a weightage of a match between the at least one class of segmented fashion objects and the fashion context; and dynamically cluster the segmented fashion objects with the assigned tag in the at least one class based on the weightage.

The processor may be further configured to execute the instructions to: determine a feature vector of the image using a Convolution Neural Network (CNN) model; determine Region of Interests (ROIs) of the image by providing the feature vector to a Region Proposal Network; optimize scales of the ROIs by providing the feature vector and the predicted ROIs to a Feature Pyramid Network (FPN); refine an alignment of the ROIs; and determine the segmented fashion objects including output masks, labels, and coordinates of the identified fashion objects in the ROIs using a plurality of neural network models.

The processor may be further configured to execute the instructions to: obtain labels of the segmented fashion objects; and performing one of: based on the labels of the segmented fashion objects being clothes, classify the segmented fashion objects into a pattern class, a fabric class, and an attire class, and based on the labels of the segmented fashion objects being fashion accessories, classify the segmented fashion objects into a fashion accessory class.

The processor may be further configured to execute the instructions to: identify each person in the image by detecting faces of people in the image; determine a relationship of each person with a user of the electronic device; segregate the segmented fashion objects of each person; and determine the personal and social attributes of the segregated fashion objects based on the relationship of each person with the user.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an electronic device for on-device lifestyle recommendations, according to an embodiment;

FIG. 2A is an architectural diagram of a fashion object recommendation engine for dynamically clustering fashion objects and displaying a lifestyle recommendation, according to an embodiment;

FIG. 2B is an architectural diagram of various components of the fashion object recommendation engine for dynamically clustering fashion objects and displaying the lifestyle recommendation, according to another embodiment;

FIG. 3 is a flow diagram illustrating a method for the on-device lifestyle recommendations, according to an embodiment;

FIG. 4A is a flow diagram illustrating a method for segmenting fashion objects identified from an image, according to an embodiment;

FIG. 4B is a flow diagram illustrating another method for segmenting the fashion objects identified from the image, according to an embodiment;

FIG. 5A is a flow diagram illustrating a method for classifying the segmented fashion objects into different classes, according to an embodiment;

FIG. 5B is a flow diagram illustrating another method for classifying the segmented fashion objects to the different classes, according to an embodiment;

FIG. 6A is a flow diagram illustrating a method for determining personnel and social attributes, according to an embodiment;

FIG. 6B is a flow diagram illustrating a method for determining a fashion context, according to an embodiment;

FIG. 6C is a flow diagram illustrating a method for dynamically clustering the fashion objects, according to an embodiment;

FIG. 7 illustrates an example scenario of dynamically clustering the fashion objects, according to an embodiment;

FIGS. 8A and 8B illustrate a comparison of the on-device lifestyle recommendations of the proposed electronic device with lifestyle recommendations of a conventional device, according to an embodiment;

FIG. 9A illustrates a comparison of text recommendations of the proposed electronic device with text recommendations of the conventional device at different example scenarios, according to an embodiment;

FIG. 9B illustrates image and text recommendations of the proposed electronic device at different example scenarios, according to an embodiment;

FIG. 10 illustrates a comparison of recommendations generated for an input photo by the conventional device and the proposed electronic device in collaboration with a Bixby vision, according to an embodiment;

FIGS. 11A, 11B, 12, and 13 illustrate example scenarios of providing on-device recommendations to users in an instant chat application, according to an embodiment;

FIG. 14 illustrate an example scenario of providing on-device recommendations to the user in an e-commerce application, according to an embodiment;

FIG. 15 illustrate an example scenario of providing on-device recommendations to the user in an image viewer application, according to an embodiment;

FIG. 16 illustrate an example scenario of providing the on-device recommendations to the user in a gallery application, according to an embodiment; and

FIG. 17 illustrate an example scenario of providing the on-device recommendations to the user for setting as a phone home screen background image or a watch-face background image, according to an embodiment

### DETAILED DESCRIPTION

Various embodiments provide a method and an electronic device for on-device lifestyle recommendations. The electronic device provides fashion-centric on-device content by performing fashion-centric personnel and social attribution of various images stored in the electronic device by analyzing the images through neural networks and brings fashion information handy to the user and solves the problem of bringing appropriate fashion content as and when needed to the user.

An aspect of various embodiments herein is to segment, extract, store, cluster, and classify personnel attributed fashion components of images stored in the electronic device and bring contextually to a user based on user interaction. The proposed method is handy during message composition, replies to photos, collaborative search, fashion smart selects and share, fashion-centric image search, feedback to e-commerce sites, and unified and outfit-matching backgrounds. The method allows the electronic device which enables the user to store, access and share the fashion content as a whole or selected part of an image or cluster formed from the components of various images

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Accordingly, the embodiments herein provide a method for on-device lifestyle recommendations. The method includes detecting, by an electronic device, a user input on the electronic device. The method includes determining, by the electronic device, a fashion context based on the user input. The method includes dynamically clustering, by the electronic device, fashion objects in images stored in the electronic device based on the fashion context. The method includes displaying, by the electronic device, a lifestyle recommendation including the clustered fashion objects.

Accordingly, the embodiments herein provide an electronic device for on-device lifestyle recommendations. The electronic device includes a fashion object recommendation engine, a memory, a processor, where the fashion object recommendation engine is coupled to the memory and the processor. The fashion object recommendation engine is configured for detecting a user input on the electronic device. The fashion object recommendation engine is configured for determining a fashion context based on the user input. The fashion object recommendation engine is configured for dynamically clustering fashion objects in images stored in the electronic device based on the fashion context. The fashion object recommendation engine is configured for displaying a lifestyle recommendation including the clustered fashion objects.

Unlike related art methods and systems, the electronic device provides fashion-centric on-device content by performing fashion-centric personnel and social attribution of various images stored in the electronic device by analyzing the images through neural networks and bringing fashion information handy to the user and solving the problem of bringing appropriate a fashion content as and when needed to the user, which improves user experience.

Unlike related art methods and systems, the electronic device segments, extracts, stores, clusters, and classifies personnel attributed fashion components of images stored in the electronic device and brings context to a user. The proposed method is handy during message composition, replies to photos, collaborative search, fashion smart selects and share, fashion-centric image search, feedback to e-commerce sites, and unified and outfit-matching backgrounds. The method allows the electronic device which enables the user to store, access and share the fashion content as a whole or selected part of an image or cluster formed from the components of various images.

Related art solutions provide a way to search fashion content in the web but the proposed method allows the electronic device to bring relevant content available on the electronic device. The proposed method also allows the electronic device to fashion-centric on-device content accessing, and recommend the right contextual content. The proposed method solves the problem by thoroughly analyzing the existing images on the electronic device in terms of various fashion aspects by using Artificial Intelligence (AI) techniques. This analysis is used to build a fashion knowledge graph of the user and the user's close community. The knowledge graph is accessed and provided to the user as and when required by sensing the fashion context of user interactions and presenting the data, building solutions by using data and providing appropriate recommendations.

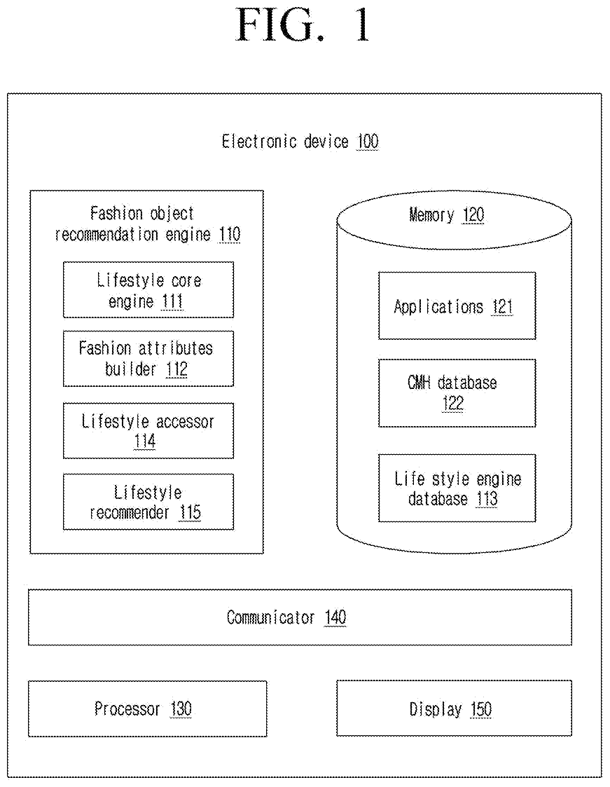

Referring now to the drawings, and more particularly to FIGS. 1 through 10, there are shown example embodiments.

FIG. 1 is a block diagram of an electronic device 100 for on-device lifestyle recommendations, according to an embodiment. Examples of the electronic device 100 include, but are not limited to a smartphone, a tablet computer, a Personal Digital Assistance (PDA), a desktop computer, an Internet of Things (IoT), a wearable device, etc. In an embodiment, the electronic device 100 includes a fashion object recommendation engine 110, a memory 120, a processor 130, a communicator 140, and a display 150, where the display 150 displays content to a user, and can receive user inputs. Examples of the display include but are not limited to a light-emitting diode screen, a liquid crystal display screen, etc. The fashion object recommendation engine 110 is implemented by processing circuitry such as logic gates, integrated circuits, microprocessors, microcontrollers, memory circuits, passive electronic components, active electronic components, optical components, hardwired circuits, or the like, and may optionally be driven by a firmware. The circuits may, for example, be embodied in one or more semiconductor chips, or on substrate supports such as printed circuit boards and the like. In an embodiment, the fashion object recommendation engine 110 includes a lifestyle core engine 111, a fashion attributes builder 112, a lifestyle accessor 114, and a lifestyle recommender 115.

The fashion object recommendation engine 110 detects the user input (e.g. user interactions, selecting a text, media, etc.) on the electronic device 100. Further, the fashion object recommendation engine 110 determines a fashion context based on the user input. Further, the fashion object recommendation engine 110 dynamically clusters fashion objects (e.g. jeans, shirt, cap, ornaments, watch, wallet, etc.) in images stored in the electronic device 100 based on the fashion context. Further, the fashion object recommendation engine 110 displays a lifestyle recommendation (e.g. image, text, etc.) including the clustered fashion objects on the display 150.

In an embodiment, for dynamically clustering the fashion objects in the images, the fashion object recommendation engine 110 identifies the fashion objects in the images by analyzing the images stored using an AI model 206. Further, the fashion object recommendation engine 110 creates a fashion knowledge graph including different classes of the identified fashion objects. Further, the fashion object recommendation engine 110 traverses the fashion context through the fashion knowledge graph. Further, the fashion object recommendation engine 110 dynamically clusters the fashion objects in the different classes obtained upon the traversal.

In an embodiment, the fashion object recommendation engine 110 updates the fashion knowledge graph based on a user action (e.g. choosing, ignoring, etc.) on the recommendation. In another embodiment, the fashion object recommendation engine 110 updates the fashion knowledge graph upon receiving and analyzing a new image.

In an embodiment, for creating the fashion knowledge graph including the different classes of the identified fashion object, the fashion object recommendation engine 110 segments the identified fashion objects from the image. Further, the fashion object recommendation engine 110 classifies the segmented fashion objects into different classes. Further, the fashion object recommendation engine 110 determines the personal and social attributes of the segmented fashion objects in the different classes. Further, the fashion object recommendation engine 110 creates the fashion knowledge graph including the different classes of the segmented fashion objects, where each segmented fashion object in each class is assigned either a personal tag or a social tag based on the personal and social attributes.

In an embodiment, for dynamically clustering the fashion objects in the different classes, the fashion object recommendation engine 110 determines a weightage of a match between the classes of segmented fashion objects and the fashion context. Further, the fashion object recommendation engine 110 dynamically clusters the segmented fashion objects with the assigned tag in the classes based on the weightage.

In an embodiment, for segmenting the identified fashion objects from the image, the fashion object recommendation engine 110 determines a feature vector of the image using a Convolution Neural Network (CNN) model 402. Further, the fashion object recommendation engine 110 determines Region of Interests (ROIs) of the image by providing the feature vector to a Region Proposal Network (RPN). Further, the fashion object recommendation engine 110 optimizes scales of the ROIs by providing the feature vector and the predicted ROIs to a Feature Pyramid Network (FPN). Further, the fashion object recommendation engine 110 refines an alignment of the ROIs. Further, the fashion object recommendation engine 110 determines the segmented fashion objects including output masks, labels, and coordinates of the identified fashion objects in the ROIs using a plurality of neural network models.

In an embodiment, for classifying the segmented fashion objects into the different classes, the fashion object recommendation engine 110 obtains labels of the segmented fashion objects. The fashion object recommendation engine 110 classifies the segmented fashion objects into a pattern class, a fabric class, and an attire class, when the labels of the segmented fashion objects are clothes. The fashion object recommendation engine 110 classifies the segmented fashion objects into a fashion accessory class, when the labels of the segmented fashion objects are fashion accessories.

In an embodiment, for determining the personal and social attributes of the segmented fashion objects in the different classes, the fashion object recommendation engine 110 identifies each person in the image by detecting the faces of people in the image. Further, the fashion object recommendation engine 110 determines the relationship of each person with the user of the electronic device 100. Further, the fashion object recommendation engine 110 segregates the segmented fashion objects of each person. Further, the fashion object recommendation engine 110 determines the personal and social attributes of the segregated fashion objects based on the relationship of each person with the user.

The memory 120 stores the images. The memory 120 includes applications 121 installed in the electronic device 100. Further, the memory 120 includes a CMH database 122, and a lifestyle engine database 113. The memory 120 stores instructions to be executed by the processor 130. The memory 120 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 120 may, in some examples, be considered a non-transitory storage medium. The term “non-transitory” may indicate that the storage medium is not embodied in a carrier wave or a propagated signal. However, the term “non-transitory” should not be interpreted that the memory 120 is non-movable. In some examples, the memory 120 can be configured to store larger amounts of information than its storage space. In certain examples, a non-transitory storage medium may store data that can, over time, change (e.g., in Random Access Memory (RAM) or cache). The memory 120 can be an internal storage unit or it can be an external storage unit of the electronic device 100, a cloud storage, or any other type of external storage.

The processor 130 is configured to execute instructions stored in the memory 120. The processor 130 may be a general-purpose processor, such as a Central Processing Unit (CPU), an Application Processor (AP), or the like, a graphics-only processing unit such as a Graphics Processing Unit (GPU), a Visual Processing Unit (VPU) and the like. The processor 130 may include multiple cores to execute the instructions. The communicator 140 is configured for communicating internally between hardware components in the electronic device 100. Further, the communicator 140 is configured to facilitate communication between the electronic device 100 and other devices via one or more networks (e.g. Radio technology). The communicator 140 includes an electronic circuit specific to a standard that enables wired or wireless communication.

Although the FIG. 1 shows the hardware components of the electronic device 100 but it is to be understood that other embodiments are not limited thereon. In other embodiments, the electronic device 100 may include less or more number of components. Further, the labels or names of the components are used only for illustrative purpose and does not limit the scope of the present disclosure. One or more components can be combined to perform same or substantially similar function for the on-device lifestyle recommendations.

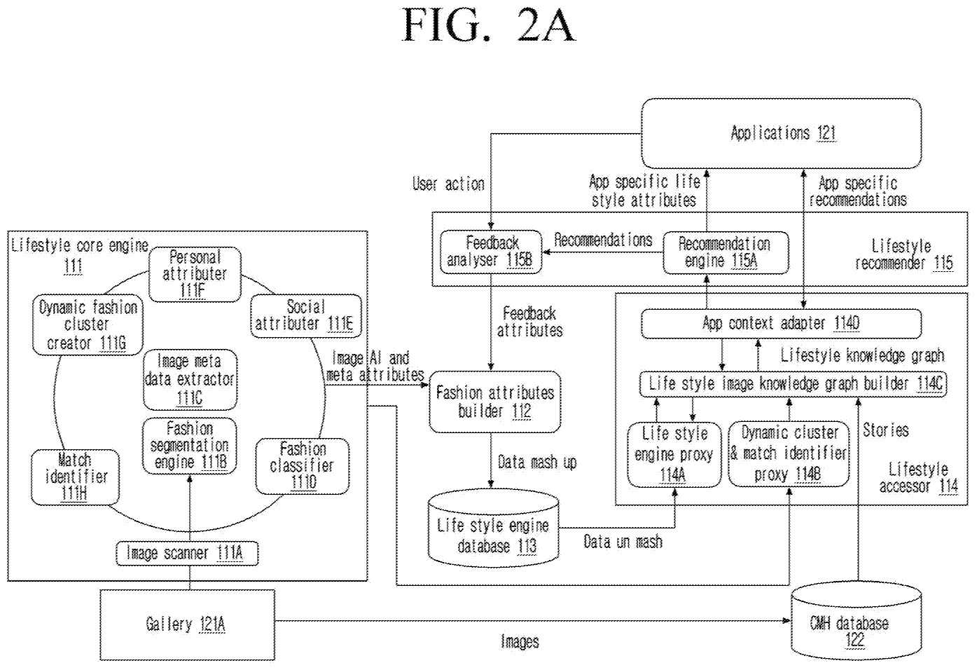

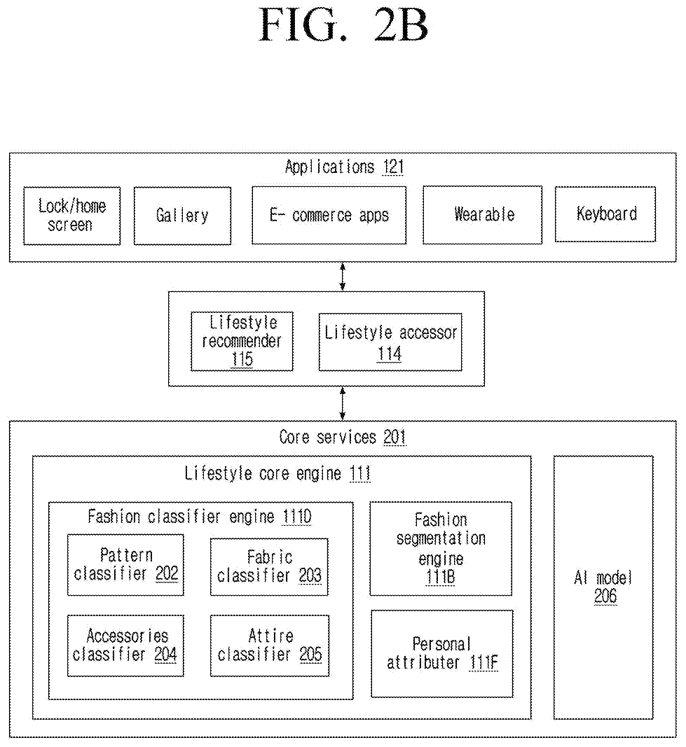

FIG. 2A is an architectural diagram of the fashion object recommendation engine 110 for dynamically clustering fashion objects and displaying the lifestyle recommendation, according to an embodiment. In an embodiment, the lifestyle core engine 111 includes an image scanner 111A, a fashion segmentation engine 111B, an image metadata extractor 111C, a fashion classifier 111D, a social attributer 111E, a personal attributer 111F, a dynamic fashion cluster creator 111G, and a match identifier 111H. In an embodiment, the lifestyle accessor 114 includes a lifestyle engine proxy 114A, a dynamic cluster & match identifier proxy 114B, a lifestyle image knowledge graph builder 114C, and an application context adapter 114D. In an embodiment, the lifestyle recommender 115 includes a recommendation engine 115A, and a feedback analyzer (115B).

The image scanner 111A periodically scans and gets the images analyzed to build the fashion knowledge graph. The fashion segmentation engine 111B segments the images in the context of the fashion i.e. type and where it is worn. The image metadata extractor 111C extracts metadata of the image (location, time, time zone etc.). The fashion classifier 111D classifies each fashion segment into different classes based on the physical and social features of the attire. The personal attributer 111F identifies the person to which fashion segment and attributes to the person. The social attributer 111E attributes the social relationship of the user and, the user's fashion segments to the other persons whose fashion segments are present. The dynamic fashion cluster creator 111G creates the clusters dynamically based on the user or use case need basis so that all relevant fashion data can be presented to the user readily. The match identifier 111H matches the different fashion segments based on their physical and social properties. The fashion attributes builder 112 collates all the images and fashion attributes built based on different fashion AI models and mash-up happens. The lifestyle engine database 113 contains all fashion data of the user and the user's social contacts are stored here.

The lifestyle engine proxy 114A is an interface through which the lifestyle attributes of the user can be extracted from the lifestyle engine database 113. The dynamic cluster & match identifier proxy 114B is an interface through which the dynamic clusters and the identified matches can be accessed. The lifestyle image knowledge graph builder 114C builds the fashion knowledge graph based on the current fashion context. The application context adapter 114D tunes the fashion knowledge graph to the current use case context and need. The recommendation engine 115A provides the recommendations based on the current context and the fashion knowledge graph that is built based on the fashion attributes. The feedback analyzer 115B analyses the user actions and feedback on the user actions on the recommendations provided so that the fashion knowledge graph can be learnt.

FIG. 2B is an architectural diagram of various components of the fashion object recommendation engine 110 for dynamically clustering fashion objects and displaying the lifestyle recommendation, according to another embodiment. The applications 121 such as a lock/home screen app, a gallery app, an e-commerce app, a wearable app, a keyboard app, etc. access core services 201 provided by the electronic device 100 through the lifestyle recommender 115 and the lifestyle accessor 114. The core services 201 are provided by the lifestyle core engine 111 and the AI model 206. The lifestyle core engine 111 includes a pattern classifier 202, a fabric classifier 203, an accessories classifier 204, and an attire classifier 205.

The fashion object recommendation engine 110 attributes segmented fashion accessories and uses them while composing a message. Further, the fashion object recommendation engine 110 provides text-driven image suggestions followed by image-driven text suggestions. The proposed method is socially collaborative, and enables the electronic device 100 for decentralized fashion searching and identifying close aid for authenticated reviews of products. The electronic device 100 performs social personalized and localized fashion searches and fashion-centric smart select in an image or screenshot for easy access to personal fashion accessories information. The proposed method is localized and supports contextual search of fashion and feeds it back to shopping apps for personalized refinement.

A function associated with the AI model 206 may be performed through the non-volatile/volatile memory 120, and the processor 130. One or a plurality of processors 130 controls the processing of the input data in accordance with a predefined operating rule or the AI model 206 stored in the non-volatile/volatile memory 120. The predefined operating rule or the AI model 206 is provided through training or learning. Here, being provided through learning means that, by applying a learning method to a plurality of learning data, the predefined operating rule or the AI model 206 of the desired characteristic is made. The learning may be performed in the electronic device 100 itself in which the AI model 206 according to an embodiment is performed, and/or may be implemented through a separate server/system. The AI model 206 may consist of a plurality of neural network layers. Each layer has a plurality of weight values and performs a layer operation through the calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks. The learning method is a method for training a predetermined target device (for example, a robot) using a plurality of learning data to cause, allow, or control the target device to make a determination or prediction. Examples of the learning method include, but are not limited to, supervised learning, unsupervised learning, semi-supervised learning, or reinforcement learning.

Although the FIGS. 2A and 2B show the hardware components of the fashion object recommendation engine 110 but it is to be understood that other embodiments are not limited thereon. In other embodiments, the fashion object recommendation engine 110 may include less or a greater number of components. Further, the labels or names of the components are used only for illustrative purpose and does not limit the scope of the present disclosure. One or more components can be combined to perform same or substantially similar function for dynamically clustering fashion objects and displaying the lifestyle recommendation.

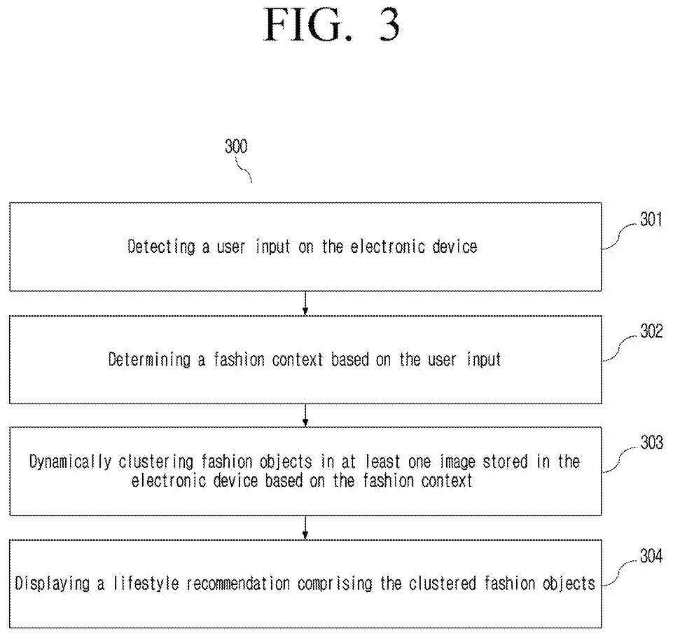

FIG. 3 is a flow diagram 300 illustrating a method for the on-device lifestyle recommendations, according to an embodiment. In an embodiment, the method allows the fashion object recommendation engine 110 to perform operations 301-304 of the flow diagram 300. At operation 301, the method includes detecting a user input on the electronic device 100. At operation 302, the method includes determining the fashion context based on the user input. At operation 303, the method includes dynamically clustering the fashion objects in the images stored in the electronic device 100 based on the fashion context. At operation 304, the method includes displaying the lifestyle recommendation including the clustered fashion objects. Below use cases are realized based on the proposed method:

Recognizing the fashion aspect in an image and suggesting a background relevant to it.

Accessing and presenting media or text based on users' communication.

Community search of fashion elements can be done in closed groups.

Personalized shopping suggestions are enabled.

Enabling fashion planning for gatherings.

Enabling fashion-centric smart selection feature.

The various actions, acts, blocks, steps, operations, or the like in the flow diagram 300 may be performed in the order presented, in a different order, or simultaneously. Further, in some embodiments, some of the actions, acts, blocks, steps, or the like may be omitted, added, modified, skipped, or the like without departing from the scope of the present disclosure.

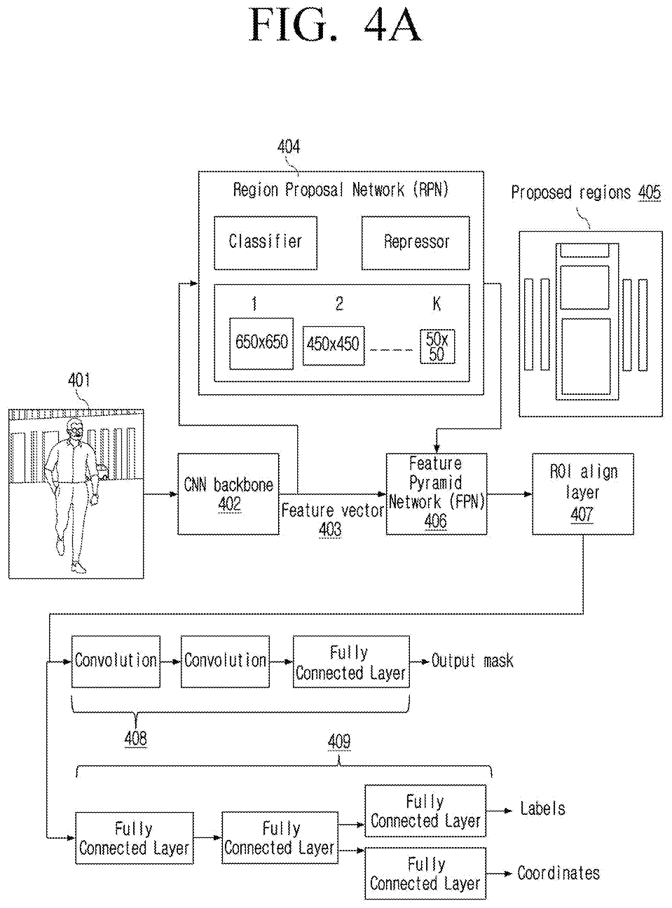

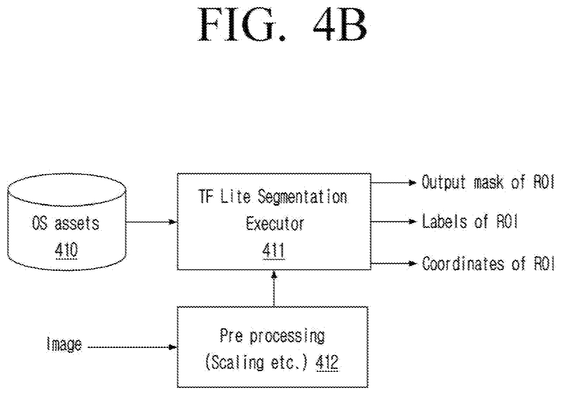

FIG. 4A is a flow diagram illustrating a method for segmenting fashion objects identified from an image, according to an embodiment. This flow diagram depicts a detailed neural architecture for fashion segmentation, where the neural architecture includes various stages of generation of the feature vector, identifying Region of Interest (ROI) areas, their alignment and final labelling of each fashion segmented region of an image. A CNN backbone 402 (e.g. Resnet/Mobilenet) extracts a feature map 403 from the input image 401. The feature map 403 is fed to the RPN 404 which proposes the possible regions of interest 405. The RPN 404 includes a classifier and a repressor. The feature map 403 and the regions of interest 405 are fed to the FPN 406 to handle different scales to avoid multiple neural networks. The ROI align layer 407 minimizes the number of regions of interest 405 received from the FPN 406. The filtered ROIs are further fed to three branches of neural nets (two convolution layers and a fully connected layer 408, four fully connected layers 409) to get segments of interest in the input image (label, coordinates, output mask). The labels can be clothes (shirt, top, pant, gown etc.), and accessories (e.g. glasses, watch, belt, shoes, earrings, anklets, necklace etc.).

FIG. 4B is a flow diagram illustrating another method for segmenting the fashion objects identified from the image, according to an embodiment. A TF lite segmentation executor 411 of the electronic device 100 preprocess (e.g. scaling) the input image and extracts the segments of interest in the input image (label, coordinates, output mask) based on Operating System (OS) assets 410.

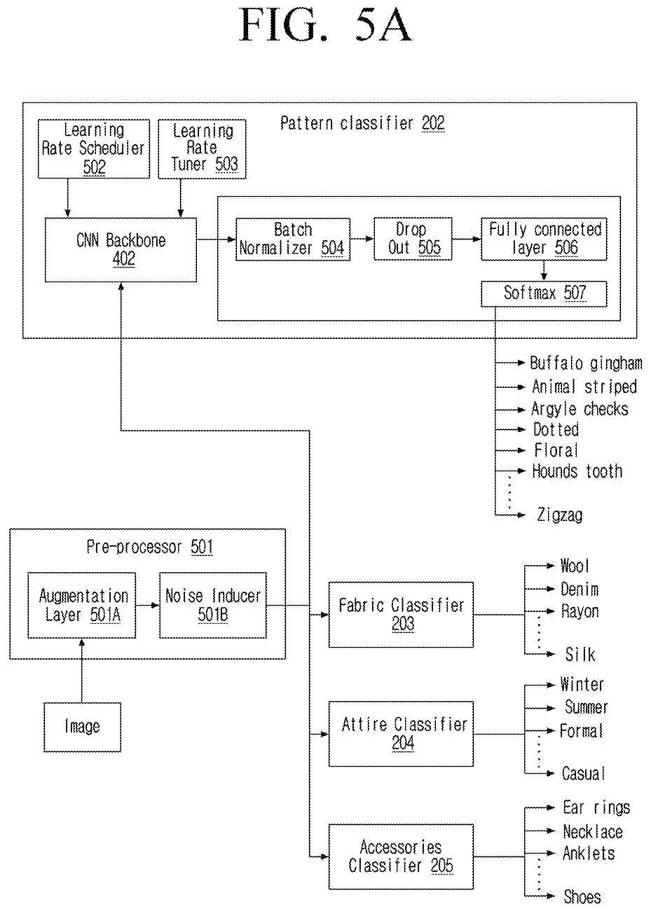

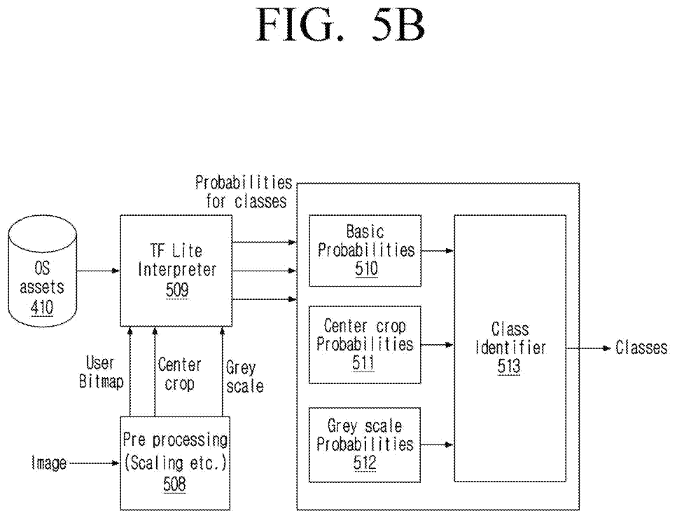

FIG. 5A is a flow diagram illustrating a method for classifying the segmented fashion objects into different classes, according to an embodiment. The FIG. 5A depicts the detailed neural architecture of fashion segmented classification. The neural architecture includes classifiers such as a pattern classifier 202, a fabric classifier 203, an attire classifier 204 and an accessories classifier 205 which share the same neural architecture but gives different classes based on classifier type. All the classifiers 202-205 receive a pre-processed image, where the input image is initially prepossessed 501 using an augmentation Layer 501A and a noise inducer 501B. The pattern classifier 202 includes the CNN backbone 402 which receives the pre-processed image and outputs of a learning rate scheduler 502, and a learning rate tuner 503. The output of the CNN backbone 402 is further passed through a batch normalizer 504, a drop out 505, a fully connected layer 506, and a Softmax layer 507 for determining the pattern present in the image such as buffalo gingham, animal striped, argyle checks, floral, hounds tooth, zigzag, etc. The fabric classifier 203 determines the fabric present in the image such as wool, denim, rayon, silk, etc. The attire classifier 204 determines the attire present in the image such as winter attire, summer attire, formal attire, casual attire, etc. The accessories classifier 205 determines the fashion accessories present in the image such as earrings, necklaces, anklets, shoes, etc.

FIG. 5B is a flow diagram illustrating another method for classifying the segmented fashion objects to different classes, according to an embodiment. The TF lite segmentation executor 411 receives the preprocessed (e.g. scaling) image and the OS assets 410, where the image is preprocessed 508 for to obtain a user bitmap, a center crop and a grayscale of the image. Further, the TF lite segmentation executor 411 determines probabilities for all classes including basic probabilities 510, center crop probabilities 511, and a greyscale probabilities 512 and provides the probabilities for all classes to a class identifier 513. The class identifier 513 identifies the different classes based on the probabilities for all classes.

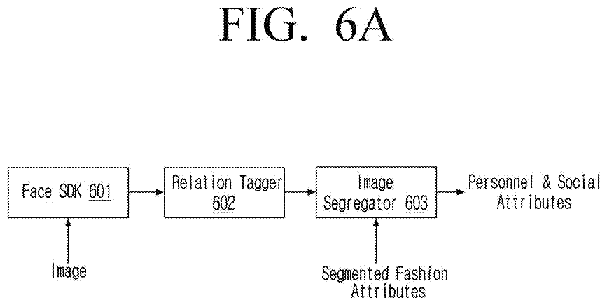

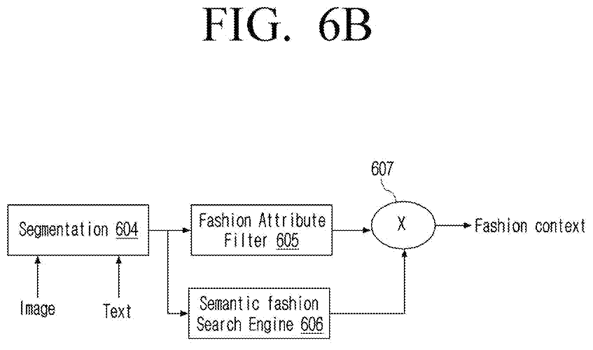

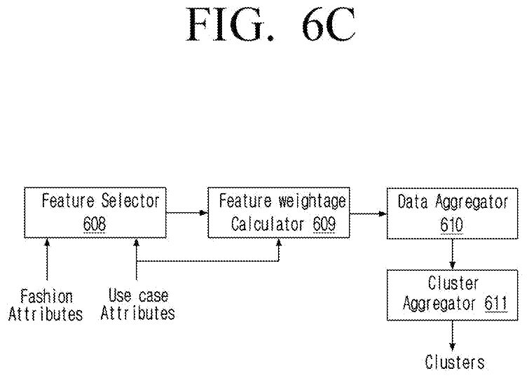

FIG. 6A is a flow diagram illustrating a method for determining personnel and social attributes, according to an embodiment. A face SDK 601 of the electronic device 100 identifies faces in the image. Further, a relation tagger of the electronic device 100 tags the identified faces. Further, an image segregator 603) of the electronic device 100 determines the personnel & social attributes of the tagged faces based on segmented fashion attributes.

FIG. 6B is a flow diagram illustrating a method for determining the fashion context, according to an embodiment. A fashion attribute filter 605 and a semantic fashion search engine 606 of the electronic device 100 receive the segmented image/text 604. The electronic device 100 determines fashion context by combining 607 on outputs of the fashion attribute filter 605 and the semantic fashion search engine 606.

FIG. 6C is a flow diagram illustrating a method for dynamically clustering the fashion objects, according to an embodiment. A feature selector 608 of the electronic device 100 determines the features of the image based on fashion attributes, and use case attributes. Further, the feature weightage calculator 609 of the electronic device 100 determines the weightage of the feature based on the use case attributes. Further, a data aggregator 610 of the electronic device 100 aggregates the feature with its weightage. A cluster aggregator 611 of the electronic device 100 forms clusters of the feature based on the weightage.

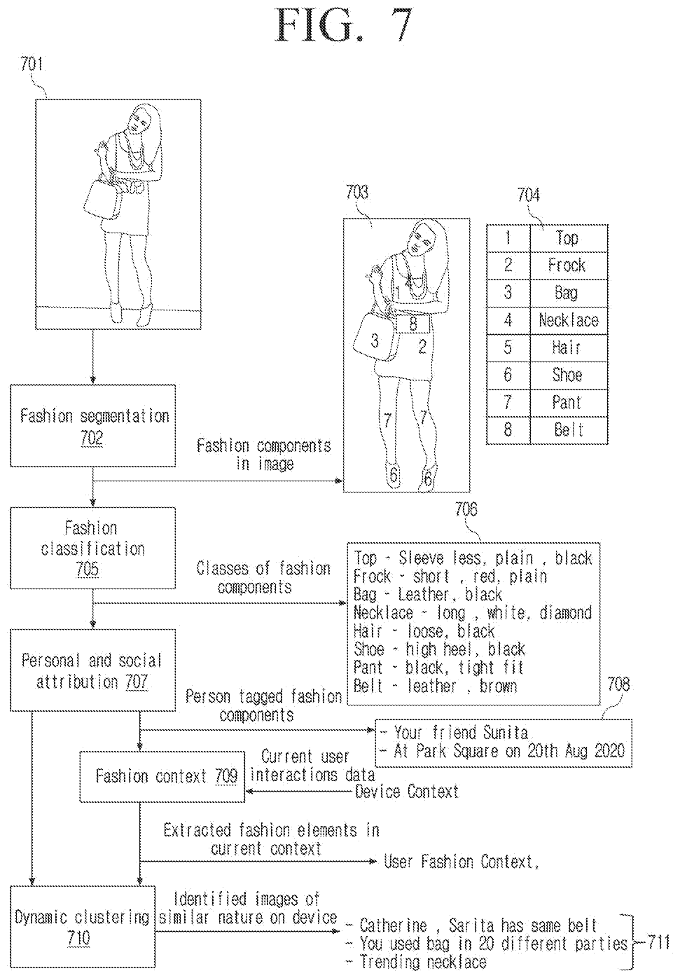

FIG. 7 illustrates an example scenario of dynamically clustering the fashion objects, according to an embodiment. The FIG. 7 depicts the kind of data that flows from one stage to another in the lifestyle pipeline, starting from the input image 701, till the final clustering of images of the such type having the same fashion properties in various terms. The electronic device 100 segments the fashion components in the image 701 as given in 703 and 704. Further, the electronic device 100 classifies the fashion components as given in 706. Further, the electronic device 100 performs the personal and social attribution 707 of the classified fashion components as given in 708. Further, the electronic device 100 detects the interaction of the user, and determines the device context. Further, the electronic device 100 determines the fashion context 709 based on the device context. Further, the electronic device 100 extracts the fashion elements in the current fashion context. Further, the electronic device 100 identifies the images of similar nature stored in the electronic device 100 based on the personal and social attributes and the fashion context and dynamically clustering 710 the similar images as given in 711.

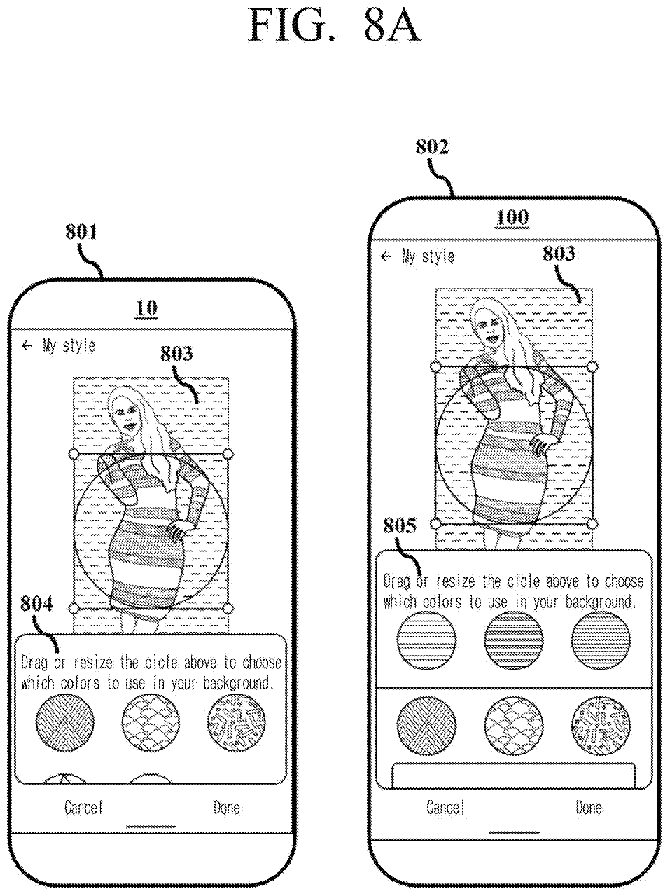

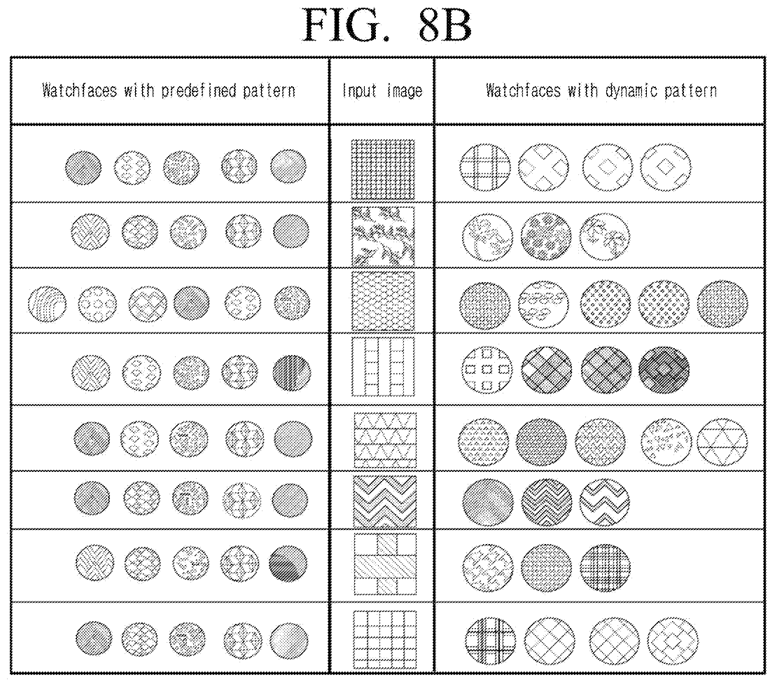

FIGS. 8A-8B illustrate a comparison of the on-device lifestyle recommendations of the proposed electronic device 100 with lifestyle recommendations of a conventional device 10, according to an embodiment. Watchfaces 804 generated based on the image 803 by the conventional device 10 are shown in 801 of the FIG. 8A. Watchfaces 805 generated based on the image 803 by the proposed electronic device 100 is shown in 802 of the FIG. 8A. The proposed electronic device 100 improves the user experience by providing dynamic patterns to the user by using the fashion object recommendation engine 110, whereas the conventional device 10 just extracts the colors and applies them on top of a predefined fixed set of patterns. The fashion object recommendation engine 110 enhances the user experience by providing dynamic patterns as per the image 803, so that it would be the appropriate match for apparel. The FIG. 8B depicts the watchfaces with a predefined pattern generated for each input image by the conventional device 10 and the s with a dynamic pattern generated for each input image by the proposed electronic device 100.

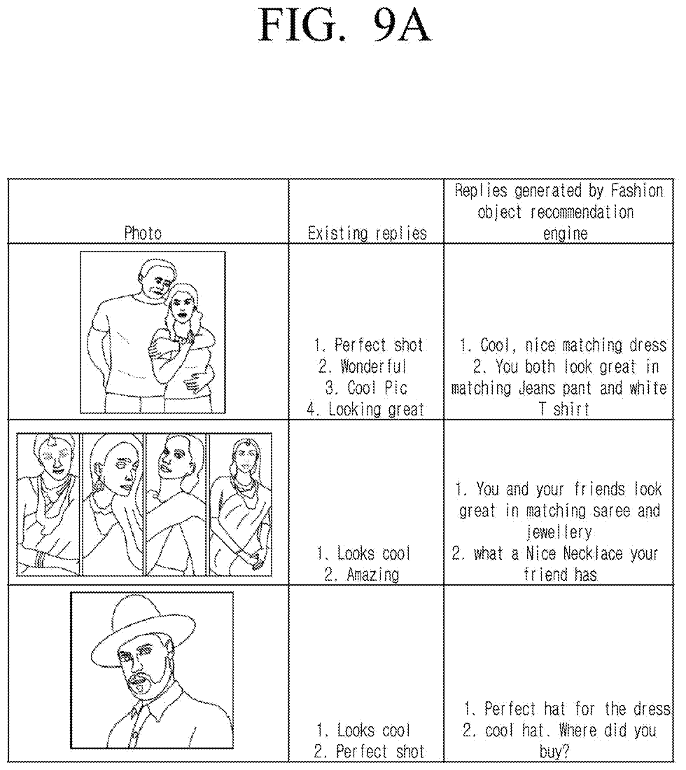

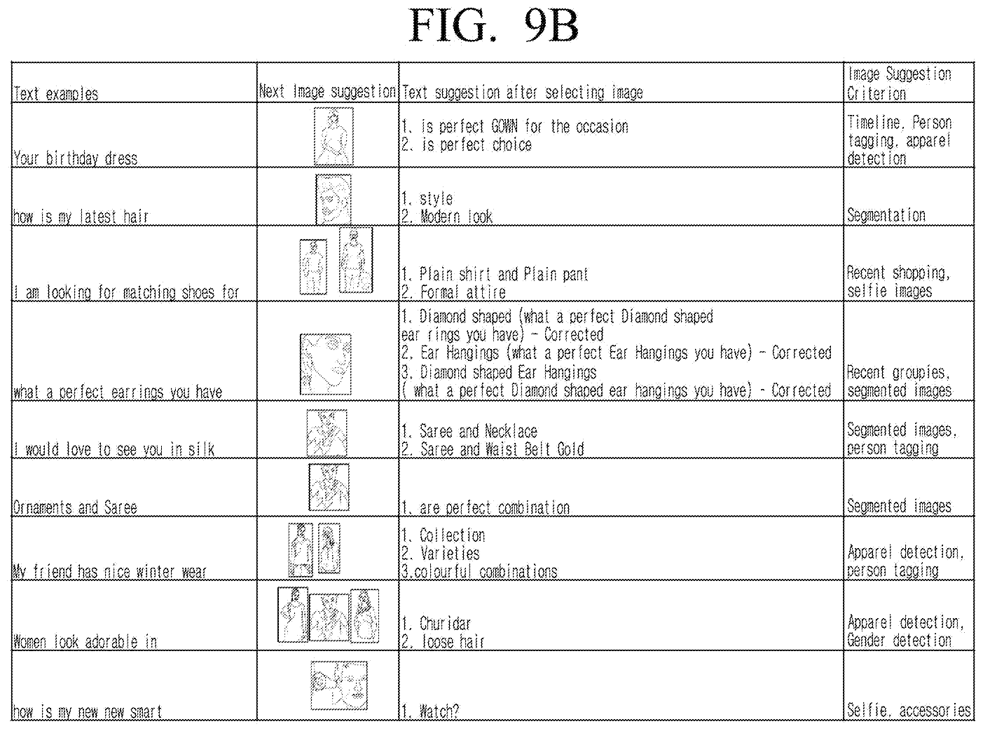

FIG. 9A illustrates a comparison of text recommendations of the proposed electronic device 100 with text recommendations of the conventional device 10 in different example scenarios, according to an embodiment. The FIG. 9A depicts how the existing photo reply (text recommendations feature can be improved by providing fashion-centric replies to the photos received and how to provide a better user experience by using the fashion object recommendation engine 110.

FIG. 9B illustrates image and text recommendations of the proposed electronic device 100 in different example scenarios, according to an embodiment. For each text typed by the user in the electronic device 100, the electronic device 100 provides the image suggestion or a text suggestion as shown in the FIG. 9B. Further, the criterion for image suggestion for each input text is also shown in the FIG. 9B.

In the example scenario, initially, the fashion object recommendation engine 110 detects the context of the fashion in the current conversation. Further, the fashion object recommendation engine 110 identifies the persons and relation of fashion elements. Further, the fashion object recommendation engine 110 generates relevant suggestions. Further, the fashion object recommendation engine 110 provides fashion-centric photo replies shown to the user.

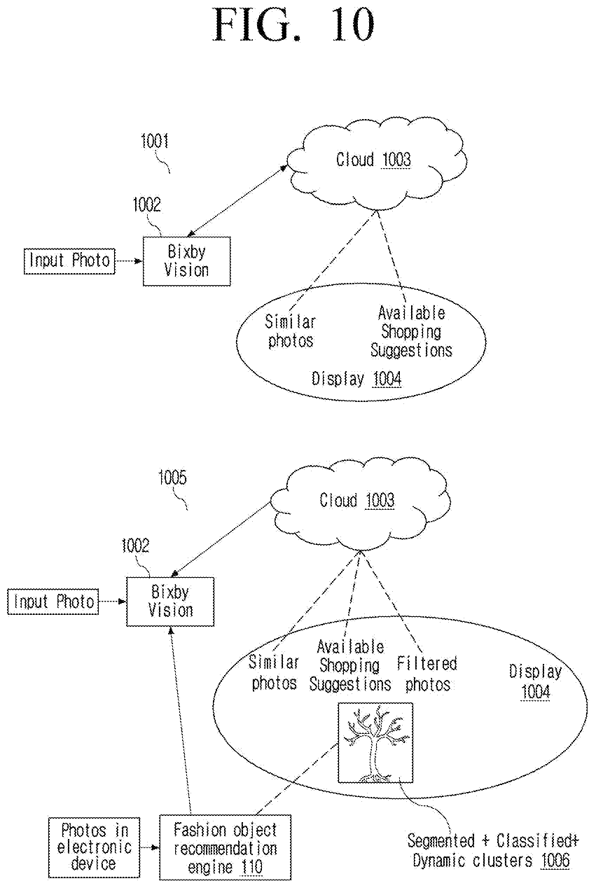

FIG. 10 illustrates a comparison of recommendations generated for an input photo by the conventional device and the proposed electronic device in collaboration with a Bixby vision, according to an embodiment. The existing Bixby vision 1002 is shown in 1101, whereas the improvement in the Bixby vision 1002 using the proposed method is shown in 1105. 1105 shows how the existing Bixby vision 1002 can be improved by converging local content and content located in a cloud 1003 by matching it with the current user's fashion context. 1105 also depicts how the fashion object recommendation engine 110 feeds data to the Bixby vision to filter the content in the cloud.

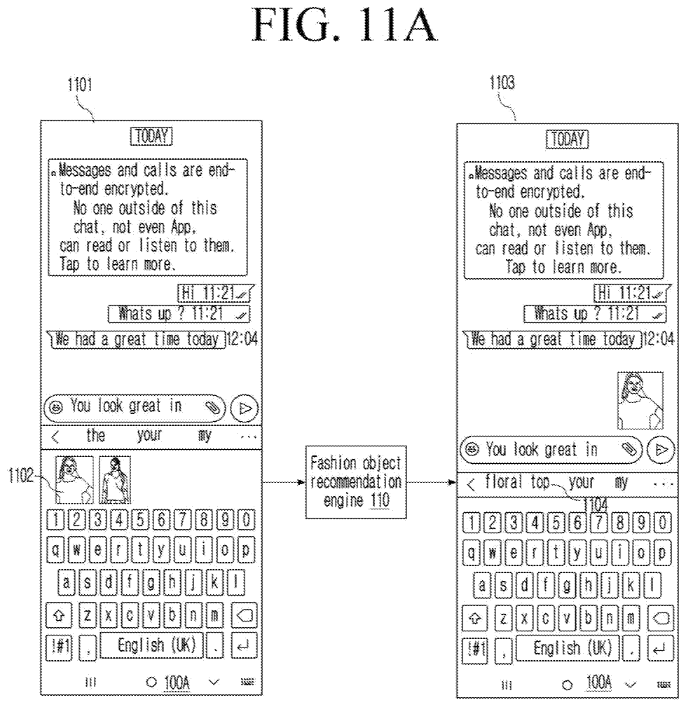

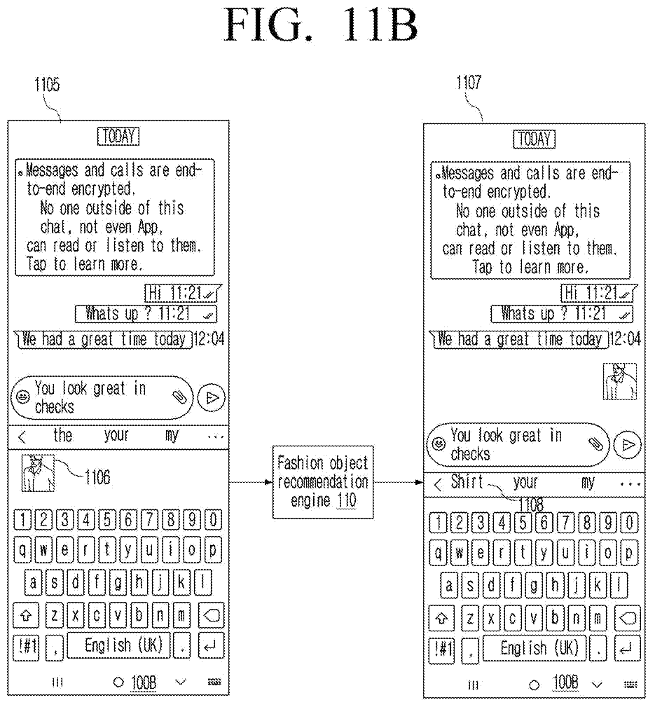

FIGS. 11-13 illustrate example scenarios of providing on-device recommendations to users in an instant chat application, according to an embodiment.

Consider, two friends Kris and Radhe met in the morning and had a conversation. Kris and Radhe wanted to complement each other by typing texts in their own electronic devices 100A, 100B (e.g. smartphone) via the instant chat application as shown in the FIG. 11. At 1101, Kris starts typing to complement Radhe in his electronic device 100A, and the fashion object recommendation engine 110 detects the context of the conversation and displays images of Radhe captured that morning using the electronic device 100A and other relevant images in that cluster as recommendation. Kris selects one image of Radhe 1102 from the recommendation. At 1103, the fashion object recommendation engine 110 converges the user-typed text, and the selected image and then suggests a followed text 1104 based on the user-selected image and previous message context.

At 1105, Radhe starts typing to complement Kris in her electronic device 100B, and the fashion object recommendation engine 110 detects the context of the conversation and displays an image of Kris captured that morning using the electronic device 100B as the recommendation. Radhe selects the image of Kris 1106 from the recommendation. At 1107, the fashion object recommendation engine 110 converges the user-typed text, and the selected image and then suggests a followed text 1108 based on the user-selected image and previous message context.

In the example scenario with reference to the FIG. 11A and FIG. 11B, initially the fashion object recommendation engine 110 detects the context of the fashion in the current conversation. Further, the fashion object recommendation engine 110 identifies persons and relations of fashion elements. Further, the fashion object recommendation engine 110 dynamically clusters relevant images and brings them to the user. Further, the user shall be able to select the compose suggestions.

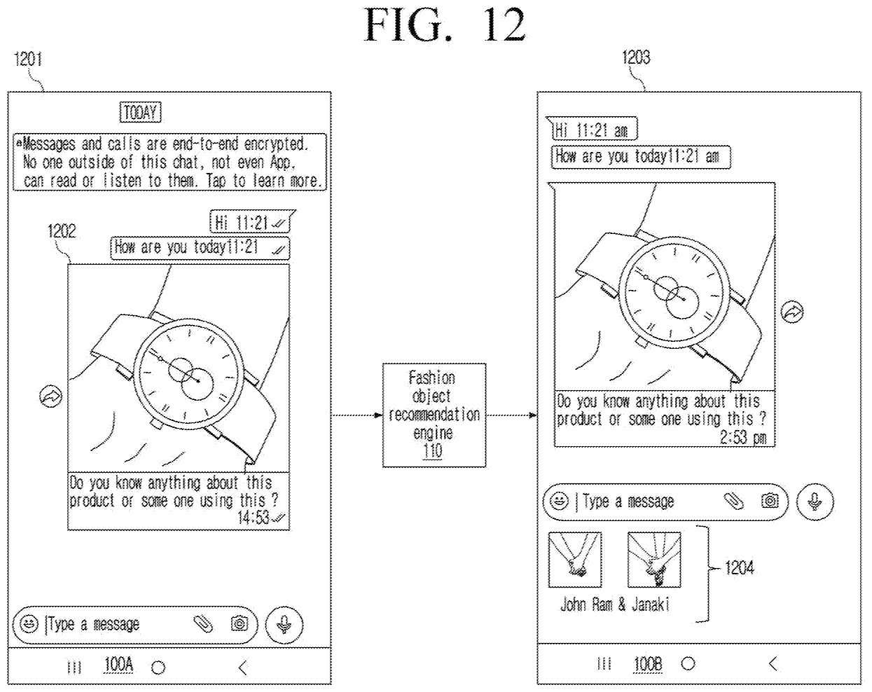

With reference to the FIG. 12, consider Krishna sent a product image 1202 using his electronic device 100A to his friend Madhav's electronic device 100B and seeking advice on the product 1202 via the instant chat application at 1201. Upon seeing the query of Krishna, Madhav started replying. Then the fashion object recommendation engine 110 fetches similar/same product images 1204 in the gallery of the electronic device 100B at 1203.

In the example scenario with reference to the FIG. 12, initially, the fashion object recommendation engine 110 detects the context in the image. Further, the fashion object recommendation engine 110 performs fashion segmentation and classification. Further, the fashion object recommendation engine 110 identifies persons and relations of fashion elements. Further, the fashion object recommendation engine 110 attaches the content to the people. Further, the fashion object recommendation engine 110 forms the cluster and gives the cluster as suggestions. Further, the fashion object recommendation engine 110 shows the suggestions to the user.

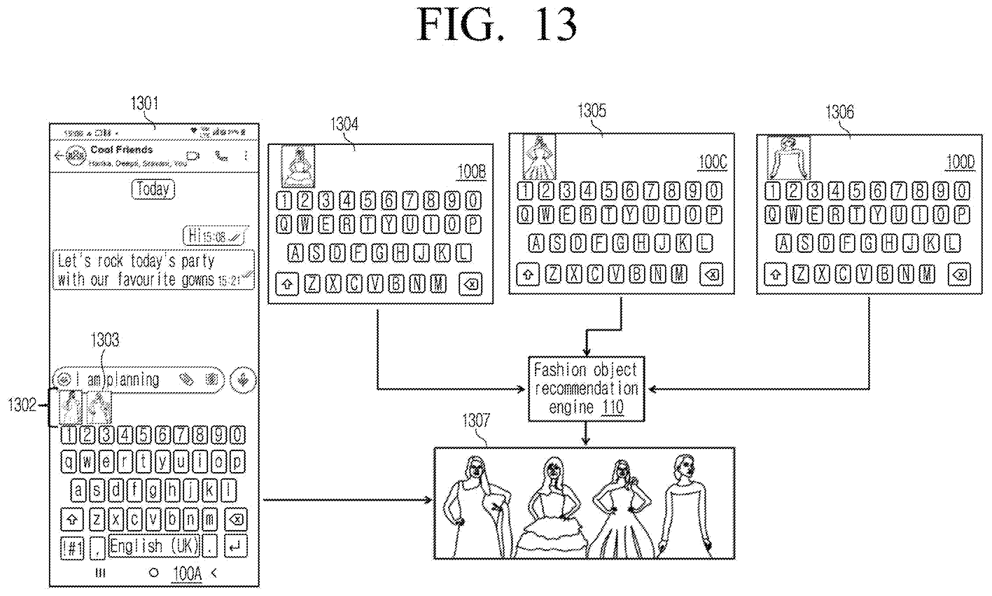

With reference to the FIG. 13, consider Mary initiates a discussion on her electronic device 100A about dress selection for a party with her friends by sending a message to the electronic devices 100A-100D of her friends via the instant chat application at 1301. The electronic device 100A of Mary suggests apparel 1302 based on the theme of the party. Further, Mary selects one apparel 303 from the suggestion. Similarly, At 1304-1306, the electronic devices 100B-100D suggest apparel based on the selection of Mary in the electronic device 100A. At 1306, upon selection of the suggested apparel by the friends, the fashion object recommendation engine 110 creates a group photo with all those selected apparel and shows how they look when they meet.

In the example scenario with reference to the FIG. 13, initially, the fashion object recommendation engine 110 detects the context from the conversation text and image. Further, the fashion object recommendation engine 110 performs fashion segmentation and classification. Further, the fashion object recommendation engine 110 attaches the content to the people. Further, the fashion object recommendation engine 110 attaches the content to the people. Further, the fashion object recommendation engine 110 forms the cluster and gives the cluster as suggestions. Further, the user can select one among the various suggestions and proceed further.

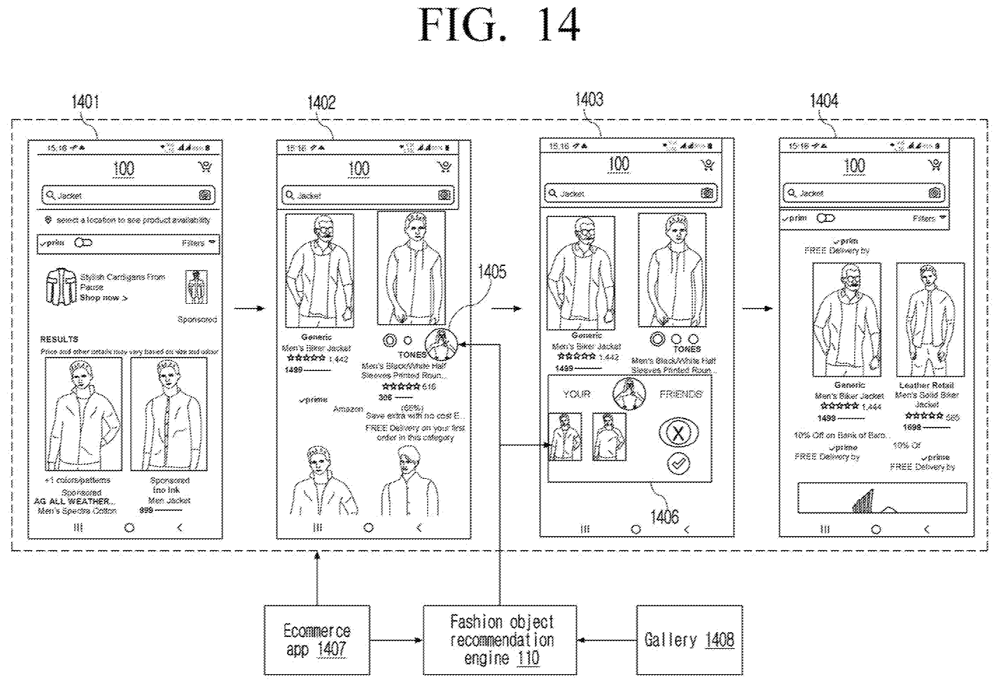

FIG. 14 illustrate an example scenario of providing on-device recommendations to the user in the e-commerce application, according to an embodiment. At 1401, consider the user opens the e-commerce application 1407 in the electronic device 100 for shopping a jacket. The fashion object recommendation engine 110 identifies the purpose of the user based on the context of the images displayed by the e-commerce application. At 1402, the fashion object recommendation engine 110 collects similar images stored in the gallery 1408 of the electronic device 100 and pops up as a floating icon 1405. At 1403, upon clicking the floating icon 1405 by the user, the fashion object recommendation engine 110 shows 1406 what the user and the user's friends have similar to what the user is shopping for. At 1404, the user shall be able to select the content the user is looking for or the content that he doesn't want, so that the e-commerce app can filter data accordingly.

In the example scenario with reference to the FIG. 14, initially, the fashion object recommendation engine 110 detects the context from the top screen. Further, the fashion object recommendation engine 110 performs fashion segmentation and classification. Further, the fashion object recommendation engine 110 attaches the content to the people. Further, the fashion object recommendation engine 110 attaches the content to the people. Further, the fashion object recommendation engine 110 forms the cluster and gives the cluster as the suggestions. Further, the e-commerce application can be fed with user selections and relevant suggestions can be refined.

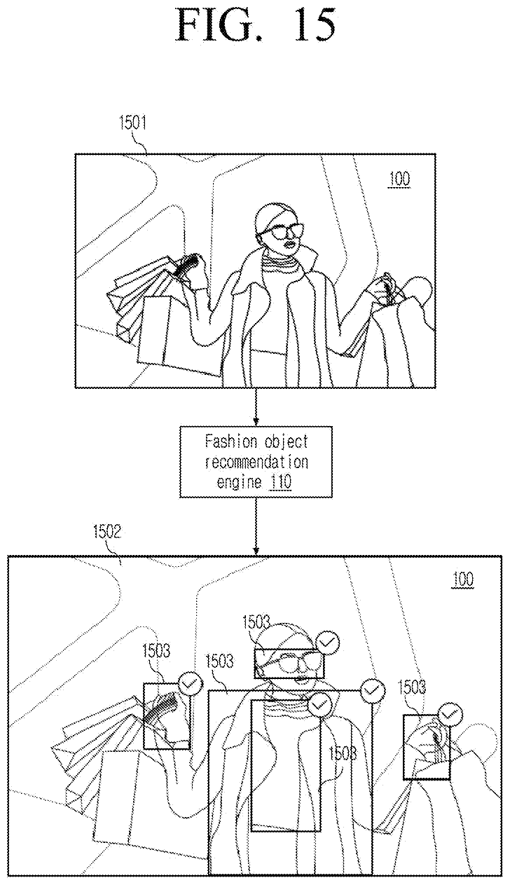

FIG. 15 illustrate an example scenario of providing on-device recommendations to the user in an image viewer application, according to an embodiment. Consider at 1501, the user is viewing an image using the image viewer application in the electronic device 100. At 1502, the fashion object recommendation engine 110 detects the fashion objects 1503 in the image, and displays an option on the fashion objects 1503 to save, modify and share, and suggests the contacts to whom it can be shared based on the content, which enhances a smart select feature on a screenshot/image.

In the example scenario with reference to the FIG. 15, initially, the fashion object recommendation engine 110 detects the context of fashion. Further, the fashion object recommendation engine 110 performs fashion classification. Further, the fashion object recommendation engine 110 attaches the content to the people. Further, the fashion object recommendation engine 110 identifies and suggests contacts to whom the fashion objects can be shared. Further, the image viewer application shows the option to save, modify and share individual fashion components.

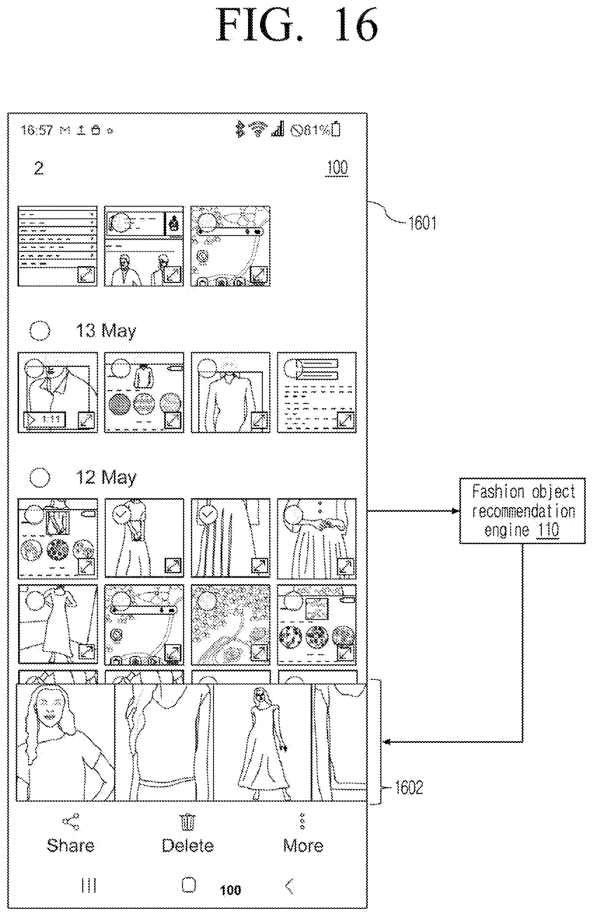

FIG. 16 illustrate an example scenario of providing on-device recommendations to the user in the gallery application, according to an embodiment. Consider at 1601, the user is selecting images in the gallery application. While selecting multiple items, the fashion object recommendation engine 110 senses the kind of images selected by the user, and pops up 1602 the suggestion to easily select the set of images.

In the example scenario with reference to the FIG. 16, initially, the fashion object recommendation engine 110 detects the user-selected images. Further, the fashion object recommendation engine 110 performs fashion segmentation and classification. Further, the fashion object recommendation engine 110 attaches the content to the people. Further, the fashion object recommendation engine 110 forms the cluster. Further, the gallery application shows smart suggestions to the user for selection.

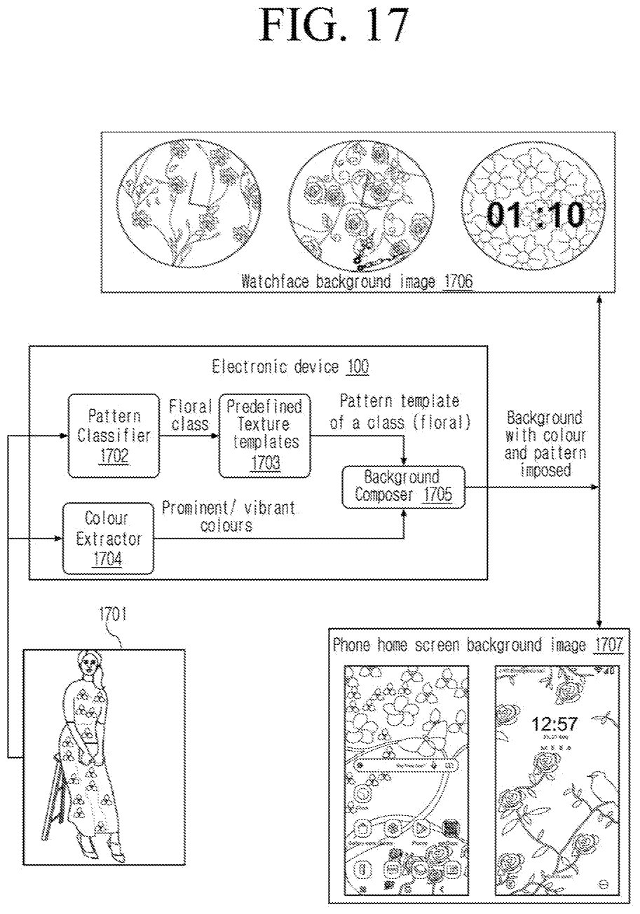

FIG. 17 illustrate an example scenario of providing the on-device recommendations to the user for setting as a phone home screen background image or a watch-face background image, according to an embodiment. Consider, the user inputs an image 1701 of a girl wearing a dress with a floral pattern to the electronic device 100. A pre-trained pattern classifier tensor-flow lite model 1702 of the electronic device 100 identifies the floral pattern of the dress in the image and outputs a floral class to the predefined texture templates 1703 in the electronic device 100. The predefined texture templates 1703 provide the pattern template of the floral class to a background composer 1705 of the electronic device 100. A color extractor 1704 of the electronic device 100 identifies the prominent/vibrant colors in the image, and provides the prominent/vibrant color information to the background composer 1705. Further, the background composer 1705 creates the phone home screen background image 1707 and/or the watch-face background image 1706 based on the pattern template of the floral class and the prominent/vibrant colors.

In the example scenario with reference to the FIG. 17, initially, the fashion object recommendation engine 110 detects the user-selected images. Further, the fashion object recommendation engine 110 performs fashion segmentation and classification. Further, the fashion object recommendation engine 110 attaches the content to the people. Further, the fashion object recommendation engine 110 forms the cluster. Further, the fashion object recommendation engine 110 creates pattern-based watchfaces.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of example embodiments, those skilled in the art will recognize that the embodiments herein can be practiced with modification within the scope of the embodiments as described herein.

What is claimed is:

1. A method of an electronic device for on-device lifestyle recommendations, the method comprising:
receiving a user input;
determining a fashion context based on the user input;
dynamically clustering fashion objects in at least one image stored in the electronic device based on the fashion context; and
displaying a lifestyle recommendation comprising the clustered fashion objects.

2. The method of claim 1, wherein the dynamically clustering the fashion objects in the at least one image comprises:
identifying the fashion objects in the at least one image by analyzing the at least one image stored using an artificial intelligence (AI) model;
generating a fashion knowledge graph comprising different classes of the identified fashion objects;
traversing the fashion context through the fashion knowledge graph; and
dynamically clustering the fashion objects in the different classes obtained based on the traversal.

3. The method of claim 2, wherein the method further comprises:
updating the fashion knowledge graph based on a user action on the recommendation.

4. The method of claim 2, wherein the method further comprises:
updating the fashion knowledge graph based on receiving and analyzing a new image.

5. The method of claim 2, wherein the generating the fashion knowledge graph comprises:
segmenting the identified fashion objects from the image;
classifying the segmented fashion objects to different classes;
determining personal and social attributes of the segmented fashion objects in the different classes; and
generating the fashion knowledge graph comprising the different classes of the segmented fashion objects, wherein each segmented fashion object in each class is assigned with either a personal tag or a social tag based on the personal and social attributes.

6. The method of claim 2, wherein the dynamically clustering the fashion objects in the different classes comprises:
determining a weightage of a match between the at least one class of segmented fashion objects and the fashion context; and
dynamically clustering the segmented fashion objects with the assigned tag in the at least one class based on the weightage.

7. The method of claim 5, wherein the segmenting the identified fashion objects from the image comprises:
determining a feature vector of the image using a Convolution Neural Network (CNN) model;
determining Region of Interests (ROIs) of the image by providing the feature vector to a Region Proposal Network;
optimizing scales of the ROIs by providing the feature vector and the predicted ROIs to a Feature Pyramid Network (FPN);
refining an alignment of the ROIs; and
determining the segmented fashion objects comprising output masks, labels, and coordinates of the identified fashion objects in the ROIs using a plurality of neural network models.

8. The method of claim 5, wherein the classifying the segmented fashion objects to the different classes comprises:
obtaining labels of the segmented fashion objects; and
performing one of:
based on the labels of the segmented fashion objects being clothes, classifying the segmented fashion objects into a pattern class, a fabric class, and an attire class, and
based on the labels of the segmented fashion objects being fashion accessories, classifying the segmented fashion objects into a fashion accessory class.

9. The method of claim 5, wherein the determining the personal and social attributes of the segmented fashion objects in the different classes comprises:
identifying each person in the image by detecting faces of people in the image;
determining a relationship of each person with a user of the electronic device;
segregating the segmented fashion objects of each person; and
determining the personal and social attributes of the segregated fashion objects based on the relationship of each person with the user.

10. An electronic device for on-device lifestyle recommendations, the electronic device comprising:
a display;
a memory storing instructions;
a processor configured to execute the instructions to:
detect a user input on the electronic device;
determine a fashion context based on the user input;
dynamically cluster fashion objects in at least one image stored in the electronic device based on the fashion context; and
control the display to display a lifestyle recommendation comprising the clustered fashion objects.

11. The electronic device of claim 10, wherein the processor is further configured to execute the instructions to:
identify the fashion objects in the at least one image by analyzing the at least one image stored using an artificial intelligence (AI) model;
generate a fashion knowledge graph comprising different classes of the identified fashion objects;
traverse the fashion context through the fashion knowledge graph; and
dynamically cluster the fashion objects in the different classes obtained based on the traversal.

12. The electronic device of claim 11, wherein the processor is further configured to execute the instructions to:
update the fashion knowledge graph based on a user action on the recommendation.

12. The electronic device of claim 11, wherein the processor is further configured to execute the instructions to:
update the fashion knowledge graph based on receiving and analyzing a new image.

13. The electronic device of claim 11, wherein the processor is further configured to execute the instructions to:
segment the identified fashion objects from the image;
classify the segmented fashion objects to different classes;
determine personal and social attributes of the segmented fashion objects in the different classes; and
generate the fashion knowledge graph comprising the different classes of the segmented fashion objects, wherein each segmented fashion object in each class is assigned with either a personal tag or a social tag based on the personal and social attributes.

14. The electronic device of claim 11, wherein the processor is further configured to execute the instructions to:
determine a weightage of a match between the at least one class of segmented fashion objects and the fashion context; and
dynamically cluster the segmented fashion objects with the assigned tag in the at least one class based on the weightage.

15. The electronic device of claim 13, wherein the processor is further configured to execute the instructions to:
determine a feature vector of the image using a Convolution Neural Network (CNN) model;
determine Region of Interests (ROIs) of the image by providing the feature vector to a Region Proposal Network;
optimize scales of the ROIs by providing the feature vector and the predicted ROIs to a Feature Pyramid Network (FPN);
refine an alignment of the ROIs; and
determine the segmented fashion objects comprising output masks, labels, and coordinates of the identified fashion objects in the ROIs using a plurality of neural network models.

16. The electronic device of claim 13, wherein the processor is further configured to execute the instructions to:
obtain labels of the segmented fashion objects; and
performing one of:
based on the labels of the segmented fashion objects being clothes, classify the segmented fashion objects into a pattern class, a fabric class, and an attire class, and
based on the labels of the segmented fashion objects being fashion accessories, classify the segmented fashion objects into a fashion accessory class.

17. The electronic device of claim 13, wherein the processor is further configured to execute the instructions to:
identify each person in the image by detecting faces of people in the image;
determine relationship of each person with a user of the electronic device;
segregate the segmented fashion objects of each person; and
determine a the personal and social attributes of the segregated fashion objects based on the relationship of each person with the user.
